(19) United States
(12) Patent Application Publication
(10) Pub. No.: US 2011/0130135 A1
(43) Pub. Date: Jun. 2, 2011

(54) COVERAGE HOLE DETECTOR

(76) Inventor: Hafedh Trigui, Ottawa (CA)

(21) Appl. No.: 12/628,442

(22) Filed: Dec. 1, 2009

(51) Int. Cl. H04W 24/00

(52) U.S. Cl. 455/423

(57) ABSTRACT

A method, program, system and apparatus for detecting coverage holes in a wireless communication network are discussed. Coverage hole detection is performed by collecting data from subscribers and extracting relevant parameters from the data. The relevant parameters are used to estimate the location of subscribers. The estimated locations are stored in a database and used to generate a coverage map for a wireless communication network.

### BACKGROUND OF THE INVENTION

1. Field of the Invention

The present invention generally relates to coverage hole detection in a wireless communication network. In particular, the present invention relates to detecting coverage holes by monitoring network information, determining location information based on the network information, and generating coverage maps using the location information.

2. Description of the Related Art

Traditional RF network planning relies on various dimensioning and capacity prediction tools. Many commercial tools are available for wireless operators to help them plan their networks. These tools make significant assumptions regarding the subscribers' distribution, the wireless channel between the transmitters and receivers, the path loss models as a function of the terrain, and the traffic demand in terms of mixed services and activity factors. Over the years, improvements have been made (e.g., by adding multiple modules) to improve the accuracy of the available tools. For example, if drive test data is available, it could be used to improve the accuracy of the path loss models, as well as the propagation channel. Such drive tests could also improve the parameters used for ray tracing models.

Capacity planning with these tools is limited to the peak busy hour (BH) traffic and does not consider traffic fluctuations at different times of the day, week, month or season. Therefore, service providers always have to consider the worst case scenario traffic in their dimensioning so they can avoid a high blockage and dropped calls/sessions rate. Factoring into their models more realistic and time-varying traffic would certainly yield a better dimensioning of hardware resources, which would ultimately reduce the capital costs for the service provider.

In addition to coverage and capacity planning, automatic cell or frequency planning modules and tools have been developed to deal with the complexity of interference management and avoidance, especially with limited available spectrum and topologies such as underlay/overlay, macro- and micro-cells, and a mix of indoor and outdoor coverage strategies and equipment (e.g., repeaters, relays, distributed antenna systems, etc.). Such tools may also use drive test data to improve the accuracy of the models, and therefore yield better frequency plans and antenna/base station parameters which translate into reduced interference and the alleviation of pilot pollution problems.

Since the wireless environment is very complex, current network planning tools can only provide an approximation of the quality of coverage and the peak number of subscribers per sector or site. RF engineers still have to tweak various configuration parameters to better manage the interference, balance the load, and correct for coverage holes that may appear at cell boundaries or, for example, other spots hidden by a cluster of high rise buildings. In general, the identification of these spots is not simple and requires investigation. The process may start by tracing dropped calls to find out their serving sectors at the drop time and monitoring the probability of occurrence over multiple weeks. Then, drive tests could be required to identify the approximate location of the dropped calls so that an RF network engineer can take this information into account when adjusting network parameters to improve the coverage area and users' experience. Typically, drive tests are limited to public properties and roads and cannot be performed in private locations, such as subscribers' houses, offices, and private land. Therefore their efficiency is questioned in many cases. Moreover, the service provider has to spend a lot of time and money (on for example, equipment, vehicles, and employees) performing the drive tests. Therefore, there is a need for a quasi-real-time tool capable of correlating the key performance indicators (KPIs) of subscribers to their geographic locations and displaying the correlated data to RF network engineers to help them optimize the network.

### SUMMARY OF THE INVENTION

An embodiment of the invention is directed to a method for detecting coverage holes in a wireless communication network. The method includes using a processor to collect subscriber data from a plurality of subscribers in a plurality of coverage areas for coverage hole detection; extract relevant information from the subscriber data; determine locations of the plurality of subscribers using the relevant information; store the relevant information from the subscriber data and the locations of the plurality of subscribers; and display a coverage map generated from the locations of the plurality of subscribers in the plurality of coverage areas.

An embodiment of the invention is directed to program recorded on a computer-readable storage medium for detecting coverage holes in a wireless communication network. This program causes a computer to execute a coverage hole detection steps that include collecting subscriber data from a plurality of subscribers in a plurality of coverage areas for coverage hole detection; extracting relevant information from the subscriber data; determining locations of the plurality of subscribers using the relevant information; storing the relevant information from the subscriber data and the locations of the plurality of subscribers; and displaying a coverage map generated from the locations of the plurality of subscribers in the plurality of coverage areas

An embodiment of the invention is directed to a system for detecting coverage holes in a wireless communication network. The system includes a network optimization apparatus operable to monitor and perform management of the communication system; a network controller operable to communicate with the network optimization apparatus; a base station operable to communicate with the network controller; an antenna array operable to communicate with, the base station and a plurality of subscribers in a plurality of coverage areas; a dynamic load balancing apparatus operable to communicate with the network optimization apparatus, the base station, and the antenna array; and a coverage hole detector operable to detect coverage holes in the plurality of coverage areas.

An embodiment of the invention is directed to a apparatus for detectin coverage holes in a wireless communication network. The apparatus includes a data collection device operable to collect subscriber data from the plurality of subscribers for coverage hole detection; a parser operable to extract relevant information from the subscriber data; a processor operable to determine locations of the plurality of subscribers using the relevant information; an information database operable to store the relevant information from the subscriber data and the locations of the plurality of subscribers; and a viewer operable to display a coverage map generated from the locations of the plurality of subscribers in the plurality of coverage areas.

### BRIEF DESCRIPTION OF THE DRAWINGS

In the drawings, like reference numbers generally indicate identical, functionally similar and/or structurally similar elements. Embodiments of the invention will be described with reference to the accompanying drawings, wherein:

FIG. 1 illustrates a system implementing the coverage hole detector in a wireless communication network in accordance with an embodiment of the invention;

FIG. 2 illustrates the components of a coverage hole detector implemented in a wireless communication network in accordance with an embodiment of the invention;

FIG. 3 illustrates a flowchart of a method of coverage hole detection in accordance with an embodiment of the invention; and

FIG. 4 illustrates a coverage hole detection apparatus in accordance with an embodiment of the present invention.

Additional features are described herein, and will be apparent from the following description of the figures.

### DETAILED DESCRIPTION OF THE INVENTION

In the description that follows, numerous details are set forth in order to provide a thorough understanding of the invention. It will be appreciated by those skilled in the art that variations of these specific details are possible while still achieving the results of the invention. Well-known elements and processing steps are generally not described in detail in order to avoid unnecessarily obscuring the description of the invention.

In the drawings accompanying the description that follows, often both reference numerals and legends (labels, text descriptions) may be used to identify elements. If legends are provided, they are intended merely as an aid to the reader, and should not in any way be interpreted as limiting.

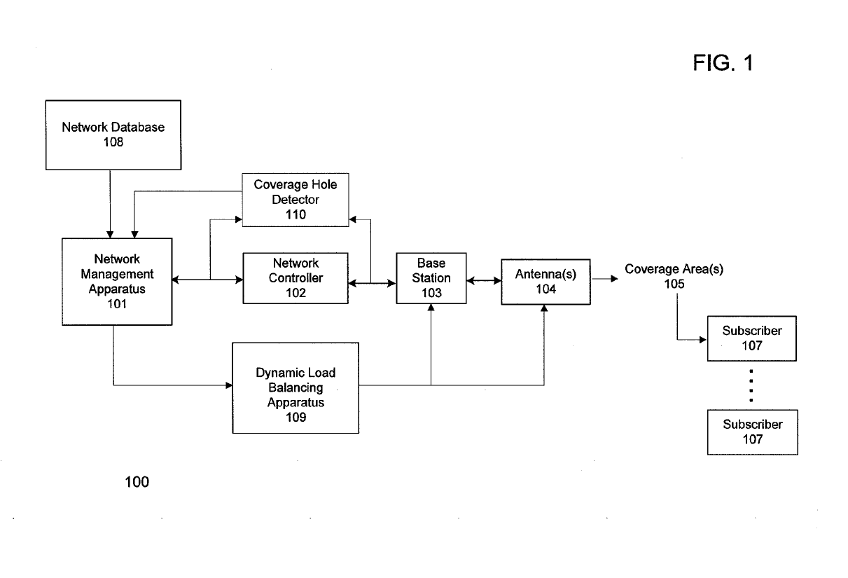

FIG. 1 is a system implementing the coverage hole detector 110 in a wireless communication network in accordance with an embodiment of the invention. In particular, the wireless communication network 100 illustrated in FIG. 1 includes a coverage hole detector 110. The wireless communication network 100 refers to any type of computer network that is wireless, and is commonly associated with a telecommunications network whose interconnections are implemented without the use of wires such as with electromagnetic waves, such as radio waves or the like as a carrier. The basic components of the wireless communication network 100 include a network management apparatus 101, a dynamic load balancing apparatus 109, one or more network controllers 102, and one or more base stations 103, having one or more antennas 104, for supporting data communications between subscribers 107 (note, subscriber refers to a subscriber's handset) distributed throughout coverage areas 105 provided by the wireless communication network 100. Please note that, although the communication network is referred to as wireless, the coverage hole detector 110 could be implemented on a partially wired network, or even an entirely wired network, as well.

The network management apparatus 101 exercises monitoring and control over the wireless communication network 100. The network management apparatus 101 may include, for example, a network operation center (NOC) that analyze problems, perform troubleshooting, communication with site technicians and other NOCs. The network management apparatus 101 may also include any server or other computer implemented to monitor and control the wireless communication network 100. Although FIG. 1 illustrates only one network management apparatus 101, it should be understood that more than one network management apparatus 101 is possible. As seen in FIG. 1, the network management apparatus 101 receives information (e.g., network statistics) related to the wireless communication network 100 for assisting in the monitoring and control functions.

The network controller 102 illustrated in FIG. 1 is a controller that can control one or more of the base stations 103 and the corresponding coverage areas 105 provided by the base stations 103. A plurality of subscribers 107 are distributed within the coverage areas 105 for participating in wireless data communications provided by the wireless communications network 100. The subscribers 107 may include various types of fixed, mobile, and portable two way radios, cellular telephones, personal digital assistants (PDAs), or other wireless networking devices.

The dynamic load balancing apparatus 109 can be a server or other similar computer device capable of executing an algorithm for performing dynamic load balancing. As illustrated in FIG. 1, the dynamic load balancing apparatus 109 is controlled by the network management apparatus 101 and can adjust certain operating parameters of the base station 103 and antennas 104.

Each coverage area 105 behaves as an independent sector serving its own set of subscribers 107. Receive diversity can be supported by the same coverage areas 105 generated by means of an orthogonal polarization in the antenna (not shown) or by totally separate antennas (not shown). Alternatively, receive diversity can be supported in angular domain by associating a coverage area 105 to one antenna port and another coverage area 105, typically the adjacent one, to another port. However, both coverage areas 105 are active in the transmit direction.

Similarly, multiple input multiple output (MIMO) modes are supported by feeding similar coverage areas 105 to each MIMO branch using polarization, angle or space domains. For fixed wireless systems, such as IEEE802.16-2004, each coverage area 105 can be used by a single base station 103 or plurality of base stations 103 operating each on a different frequency channel. For mobile systems, subscribers 107 of a single coverage area 105 are served by a single base station 103 that can be a single frequency channel for supporting communications in accordance with IEEE802.16e-2005 or multiple frequency channels for supporting communications in accordance with IEEE802.16m.

Wireless communication networks 100 have a default radio location method, called Cell-ID, to track the best serving sector of each of the subscribers 107 to ease establishing calls and roaming, as well as troubleshooting whenever required (e.g., counting dropped calls for a specific sector). The Cell-ID is unique for each operator's network sector and corresponds to a specific coverage area 105. Therefore, a coverage map for all the sectors in the network could provide a preliminary idea of the location of a subscriber 107, if its Cell-ID is known. Coverage maps are predicted by network planning tools or obtained by data from field measurements. In the absence of other methods, coverage maps are important for public safety to roughly locate emergency calls, but generally do not help RF engineers in identifying poor coverage areas.

The coverage hole detector 110 monitors communication between the network controller 102 and the base station 103, the network controller 102 and the network management apparatus 101, or both. As described below, the coverage hole detector 110 provides a way to improve the accuracy of identifying a subscriber's location by taking into account additional subscriber information.

By monitoring the communications between the network controller 102, the base station 103, and the network management apparatus 101, the coverage hole detector 110 can extract the information necessary to determine the round trip delay between the subscriber (SS) and the serving base station (BS), which indicates how far the subscriber 107 is from the base station 103. This radius information provides extra information to the RF engineer to change relevant network parameters. For example, if dropped calls for a particular sector happen more often at a cell edge, it might make sense to adjust the antenna tilt and base station transmit power values to expand or shrink the cell coverage. After changing some parameters, additional subscribers' data (e.g., round trip delays and dropped calls) is gathered to validate the most recent changes made by the RF network engineer.

For large cells, the radius could be very large, especially closer to a cell edge, and in some situations, it could be advantageous to also have the angle information to reduce the ambiguity in locating coverage problems. Such information is obtained from a base station 103 equipped with an antenna array allowing for direction of arrival estimation on the uplink signals. In such a case, the location of each subscriber 107 could be estimated more accurately.

In addition to the location noted above, there are several quality metrics associated with each subscriber that can be used by the coverage hole detector, such as Received Strength Signal Indication (RSSI), Carrier to Interference-plus-Noise Ratio (CINR), and uplink/downlink throughput, to provide more accurate location information. These quality metrics are either measured by the subscriber 107 and reported to base station 103 or measured at the base station 103. Therefore, using this information the coverage hole detector 110 could associate a location with a measured quality metric and display a coverage map to the RF engineer. The coverage map is then used by the RF engineer to tweak parameters such as antenna tilt, BS transmit power, and possibly the frequency plan, to improve the coverage area 105, especially at cell edges. The changes made on the network would be validated by gathering more measurements and showing them on the map. The RF engineer could assess the success of his changes by looking, for example, at before and after coverage maps and see improvements or degradations. Complex coverage problems may require a number of iterations to be solved. The process continues indefinitely and the quasi-real-time coverage map could be updated if displayed on the screen or displayed on demand for a time period of a few hours or days.

Since the coverage map relies on actual subscribers' handsets, the density will not generally be uniform. Geographic areas with low call activities would require more time to gather enough statistics to display. Alternatively, a uniform grid could be used and for display purposes data could be interpolated to fill in any empty pixels. Another solution would be to install test handsets in weak areas and periodically trigger the handset to be active so that measurements could be made. Some combination of these methods could also be used.

It is clear that showing quality metrics in an efficient format, by the coverage hole detector 110, to the service provider so that he could take appropriate timely decisions to improve his network before receiving quality related complaints from the customers is very important. The savings to the operator are clear since the need to perform drive tests is eliminated. In addition, since an RF engineer can start solving a coverage problem before it is magnified and causes more severe disruptions, the time savings can be substantial.

Installing antenna arrays in each cell is an expensive option for obtaining angle information for the sake of enhancing radio location algorithms. An alternative, supported today by many standards such as 3GPP, 3GPP2 and WiMAX Forum, is to enable time differences estimation between both (1) the serving sector and neighboring sectors in the downlink direction and (2) between a received signal by the serving sector and adjacent sectors in the uplink

The observed time of arrivals facilitate network-based location methods, especially for mobiles in handover regions, since time of arrival could be used as one of the handover metrics. Apart from public safety and law enforcement requirements for locating any call with specific accuracy, there are innovative applications such as location-aware advertising for promotional offers and coupons that enable new revenue to service providers and for the businesses. Observed times of arrivals for downlink are embedded in measurement report messages (MRM) from the user terminals or could be measured at the base station for the uplink direction.

The necessary measurement reports for the coverage hole detector 110 were specified for the Universal Mobile Telecommunications System (UMTS) standard in 3GPP TS25.215. 3rd generation Partnership Project; Technical Specification Group, Radio Access Network; Physical layer—Measurements (FDD); Release 8. Developing the best radio location algorithms for locating subscribers in a network so that the detection of the trouble areas is as accurate as possible is beyond the scope of this disclosure.

Taking UMTS as an example and assuming one chip resolution for the reported time delays, the best possible network-based location accuracy would be 78 meters. For 3GPP2, assuming half chip resolution, the best achievable location accuracy would be 120 meters. Although GPS location estimate is not accurate for subscribers inside most buildings, it is advantageous to consider GPS location for subscribers outside buildings, if possible, to help improving the overall accuracy, especially if the buildings are discrete and do not span large areas. It is expected that the limited number of outdoor subscribers having GPS capability will dramatically enhance the location accuracy, and today many phones are equipped with GPS capability.

Since we are looking for coverage holes, the requirements for accurate radio location estimates are not exact. Moreover, unlike E911, it is not catastrophic to miss the location of few connected mobile stations since the coverage map is built over time and considers most active connections resulting in one or more location estimates.

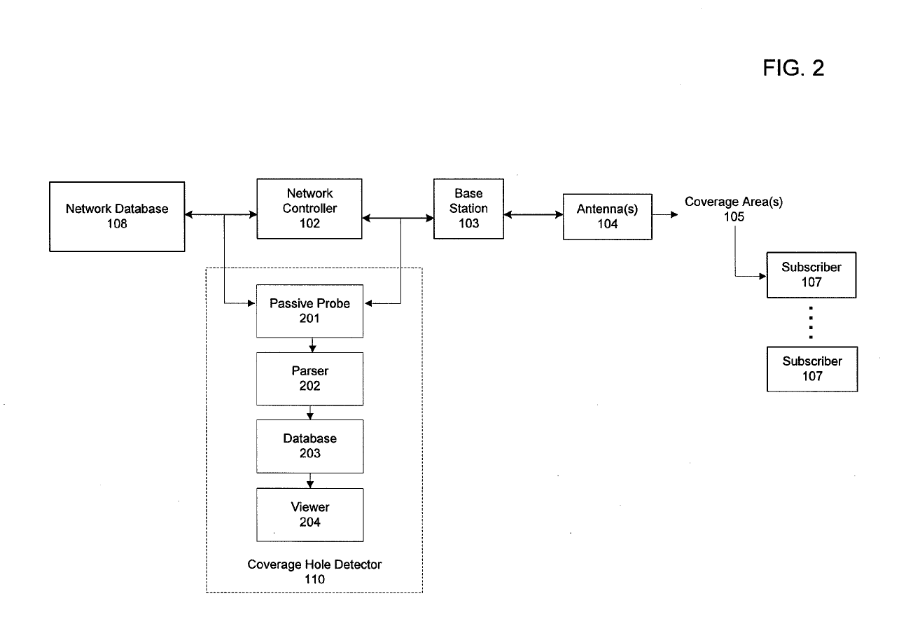

FIG. 2 illustrates the components of a coverage hole detector 110 implemented in a wireless communication network in accordance with an embodiment of the invention. In particular, FIG. 2 focuses on the components of the coverage hole detector 110 and omits the network management apparatus 101 and the dynamic load balancing apparatus 109.

As shown in FIG. 2, the main components of the coverage hole detector 110 are a passive probe 201, a parser 202, a database 203, and a viewer 204. The passive probe 210 monitors the communications between the base station 103 and the network controller 102, the network controller 102 and the network database 108 (or network management apparatus 101), or both, and extracts relevant messages used in coverage hole detection. The parser 202 extracts the necessary information fields from the relevant messages. The fields are stored in a database 203 and associated with a location. After the information has been associated with a location, a coverage map is generated and displayed on the viewer 204. The operation of the coverage hole detector 110 is described in detail below.

As described above, the coverage hole detector 110 monitors the information exchanged between the base station 103, the network controller 102 and the network management apparatus 101. The various measurements that could be used by the coverage hole detector 110 are described in Layer 1 of the Universal Mobile Telecommunications System (UMTS) standard, which provides the measurement specifications for a number of measurement abilities for the subscriber 107 and the UMTS Terrestrial Radio Access Network (UTRAN). These measurements can be differentiated in different reported measurement types, such as intra-frequency, inter-frequency, inter-system, traffic volume, quality, and subscriber internal measurements.

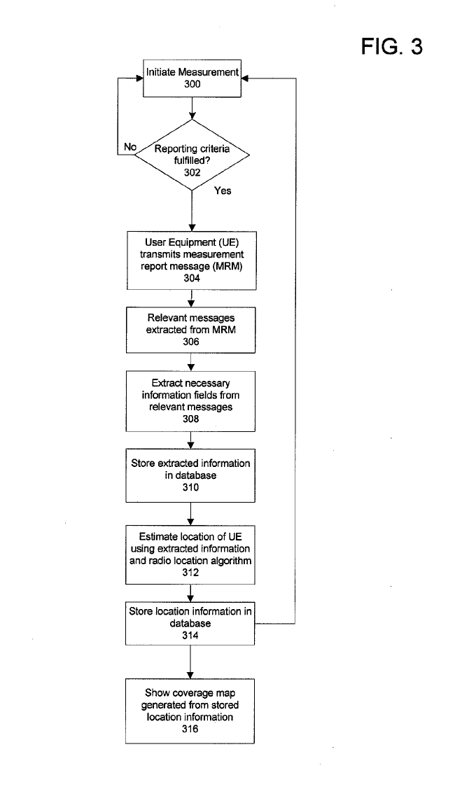

As shown in FIG. 3, to initiate a specific measurement 300, the UTRAN transmits a measurement control message to the subscriber including a measurement ID and type, a command (setup, modify, release), the measurement objects and quantity, the reporting quantities, criteria (periodical/event-triggered) and mode (acknowledged/unacknowledged).

When the reporting criteria are fulfilled 302, the subscriber answers 304 with a measurement report message (MRM) to the UTRAN including the measurement ID and the results. In idle mode the measurement control message is broadcast with system information.

Intra-frequency reporting events, traffic volume reporting events, and subscriber internal measurement reporting events, define events which trigger the subscriber to send a report to the UTRAN. This defines a toolbox from which the UTRAN can choose the needed reporting events.

Processing the MRMs, to extract 306 the relevant messages for coverage hole detection, is done by a passive probe 201, as shown FIG. 2, or alternately could be done in the network controller 102. A parser 202 then extracts 308 the necessary information fields from the relevant messages. The necessary information fields are stored 310 in a database 203. A radio location algorithm, using mainly observed time difference (OTD), Round Trip Time (RTT), and possibly Received Strength Signal Indication (RSSI), estimates 312 the location of each of the subscribers and stores 314 the location in the database 203. Therefore, subscriber specific statistics such as uplink UL and downlink DL throughput, RSSI, CINR, and Block Error Rate (BLER), are now correlated with a location. A viewer 204 the shows 316 a coverage map generated from this correlated information. Since the process is continuous, the coverage maps are quasi real-time. The time between consecutive refreshes of the maps could be uniform or non-uniform and optimized for the best performance of a product. The oldest data could be deleted so that an operator always has the most recent and accurate status of the network. The deletion of older data might be quicker in a higher density subscriber area. In a weaker density subscriber area, it might be preferable to keep older data for a longer time rather than showing blank spots (pixels) in the coverage map.

As described above, the database 203 is one of the main components of the coverage hole detector 110. The following table specifies a set of static parameters for each cell that changes only from time to time whenever an upgrade in some sites is needed.

TABLE 1
List of Static Cell Parameters

| Name | Unit | Description |
|---|---|---|
| Sector Name | N/A | Serving sector name or ID |
| Pilot Scrambling | N/A | Only 512 PSCs are available in UMTS |
| Code | | |
| BS antenna height | m | To be used by the viewer if necessary |
| Sector Location | m | GPS coordinates converted to (X, Y) |
| | | coordinates |
| Pilot Power | dBm | Constant and provisioned |
| RF Carriers | MHz | At least the primary carrier is required |

In addition to the static parameters, Table 2 is a list of dynamic cell parameters that need to be gathered more frequently (every few minutes or each hour) since they depend on the carried traffic by the cell.

TABLE 2
List of Dynamic Cell Parameters

| Name | Unit | Description |
|---|---|---|
| Time stamp | | Absolute or derived from frame number |
| Received total wide | dBm | also known as UL Total Noise. Needed to |
| band power | | compute Eb/Nt |
| Transmitted carrier | | Good indication for DL power utilization |
| power | | |

Finally, Table 3 is a list of MRMs that are used by the coverage hole detector 110. The definitions of the fields are well documented in the UMTS standard. These MRMs are per subscriber 107.

TABLE 3
List of Measurement Report Messages (MRMs)
(note that UE is the subscriber)

| Name | Unit | Description |
|---|---|---|
| Time stamp | | Either absolute or related to frame number |
| UE ID | N/A | |
| Serving Sector | N/A | “Best Server” |
| ID | | |
| UE's neighbors | N/A | MRMs are available pre and during handover |
| list | | |
| CPICH RSCP | dBm | Could be calculated as “Pilot Power” − |
| | | “Total Loss of the serving sector”. |
| UTRA carrier | dBm | |
| RSSI | | |
| CPICH Ec/N0 | dB | Could be computed as CPICH RSCP − |
| | | UTRA carrier RSSI |
| BLER/BER | % | Available for some radio access technologies. |
| | | Alternatively, consider UL and DL throughputs. |
| UE Tx Power | dBm | |
| SFN-SFN | chips | This relative timing difference (RTD) between |
| OTD | | two cells |
| SFN-CFN | chips | |
| OTD | | |
| UE Rx-Tx time | chips | This is the round trip delay |
| difference | | |
| DL Ec/Io | dB | Used by viewer |
| SIR | dB | Used by viewer |
| Transmitted | dBm | This is “Cell TCH Power for serving sector” |
| code power | | |
| Round Trip | chips | Calculated for UL and is accurate at ¼ chip |
| Time | | or better. |
| PRACH propa- | chips | Calculated and it is one-way propagation delay |
| gation delay | | as measured during PRACH access |
| UTRAN SFN- | chips | RTD between two cells as measured by LMU |
| SFN OTD | | |

In addition to cell-ID, assisted GPS, network-based methods relying on time of arrivals and differences, radio location algorithms may use side information such as terrain type (e.g., flat, mountains, water and lakes . . . ) as well as morphology (e.g., streets, buildings, highways) to improve accuracy and discard outliers.

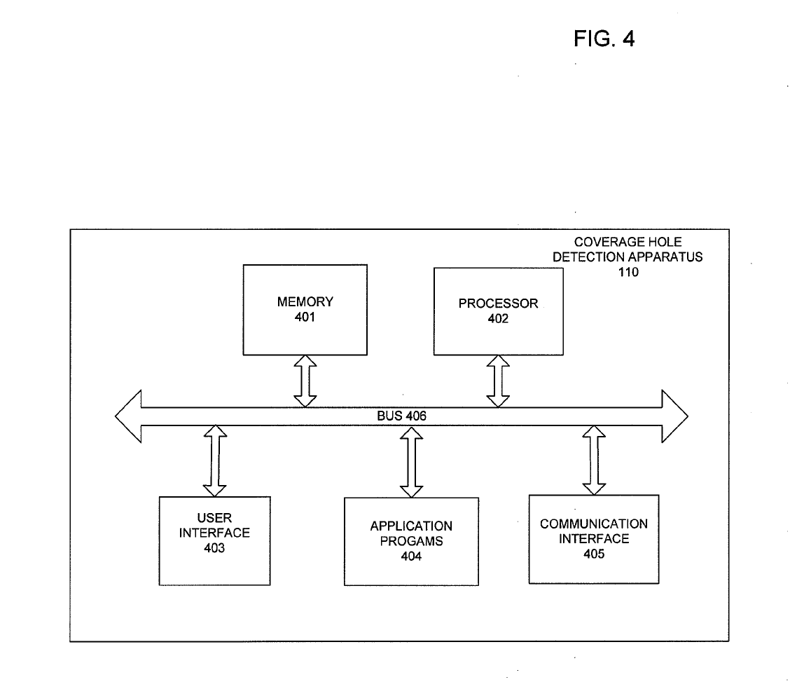

FIG. 4 is a more detailed description of the coverage hole detector 110, illustrated in FIGS. 1 and 2, for performing the method of coverage hole detection, as previously described with reference to FIG. 3. In FIG. 4, the coverage hole detection apparatus 110 includes a memory 401, a processor 402, user interface 403, application programs 404, communication interface 405, and bus 406.

The memory 401 can be computer-readable storage medium used to store executable instructions, or computer program thereon. The memory 401 may include a read-only memory (ROM), random access memory (RAM), programmable read-only memory (PROM), erasable programmable read-only memory (EPROM), a smart card, a subscriber identity module (SIM), or any other medium from which a computing device can read executable instructions or a computer program. The term “computer program” is intended to encompass an executable program that exists permanently or temporarily on any computer-readable storage medium as described above.

The computer program is also intended to include an algorithm that includes executable instructions stored in the memory 401 that are executable by one or more processors 402, which may be facilitated by one or more of the application programs 404. The application programs 404 may also include, but are not limited to, an operating system or any special computer program that manages the relationship between application software and any suitable variety of hardware that helps to make-up a computer system or computing environment of the coverage hole detection apparatus 110. General communication between the components in the coverage hole detection apparatus 110 is provided via the bus 406. The coverage hole detection algorithm as described with reference to FIG. 3, can be stored, for example, in the memory 401 of the coverage hole detection apparatus 110.

The user interface 403 allows for interaction between a user and the coverage hole detection apparatus 110. The user interface 403 may include a keypad, a keyboard, microphone, and/or speakers. The communication interface 405 provides for two-way data communications from the coverage hole detection apparatus 110. By way of example, the communication interface 405 may be a digital subscriber line (DSL) card or modem, an integrated services digital network (ISDN) card, a cable modem, or a telephone modem to provide a data communication connection to a corresponding type of telephone line. As another example, communication interface 405 may be a local area network (LAN) card (e.g., for Ethernet or an Asynchronous Transfer Model (ATM) network) to provide a data communication connection to a compatible LAN.

Further, the communication interface 405 may also include peripheral interface devices, such as a Universal Serial Bus (USB) interface, a Personal Computer Memory Card International Association (PCMCIA) interface, and the like. The communication interface 405 also allows the exchange of information across one or more wireless communication networks. Such networks may include cellular or short-range, such as IEEE 802.11 wireless local area networks (WLANS). And, the exchange of information may involve the transmission of radio frequency (RF) signals through an antenna (not shown).

Improving the Accuracy of Network Planning Tools

Apart from being an analysis and diagnosis tool to help operators detect and correct coverage problems quickly and cost efficiently, the coverage hole detector 110 provides additional information that improves other planning and optimization functions. For example, rather than making assumptions about traffic maps or subscriber lists the RF engineer could use more realistic subscribers density and traffic demand based on the average or peak or any percentile statistics gathered by the coverage hole detector 110.

Measurements such as Received Signal Strength Indicator (RSSI) or received code power, when correlated to geographic locations by means of the coverage hole detector 110, would be a much better alternative to drive tests to tweak the propagation channels and path loss models used by a network planning tool. All that would be needed would be to supply the data (RSSI for a number of discrete locations), in an appropriate format for the already available drive tests plug-ins, to the RF network planning tools. There is no need to change the algorithms implemented in the drive tests plug-ins, since the drive tests are simply substituted by the equivalent data gathered from the coverage hole detector 110. Clearly, there are tremendous benefits to service providers in reducing the time to get the data and the reducing the costs associated with the equipment and the employees needed to perform the drive tests. Also, after some period of time, the propagation and path loss models for all the sectors in the network would be calibrated and therefore the RF network planning tool will provide better capacity and coverage predictions.

To fully exploit the capabilities of the coverage hole detector 110 for improving propagation channels and path loss models, Carrier to Interference-plus-Noise Ratio (CINR) information correlated to geographic locations could be used as well. For the downlink direction, the interferers to each subscriber (or pixel in the coverage map would be a good enough approximation for the subscriber) are the base stations, whose locations are fixed. This facilitates modifying the algorithms and estimating the necessary path loss and propagation parameters. For the uplink direction, using CINR information is more complex, since all simultaneously active subscribers, within the first two tiers at least, shall be considered. This slows down the estimation process. However, this is an offline process and the lowest priority could be allocated to it

Commercial RF network planning tools provide many choices and algorithms to users and can recommend default algorithms and threshold values according to a terrain type, convergence rate, or accuracy target. However, there is a desire from mainly wireless infrastructure companies to have their proprietary algorithms (interference cancellation, MIMO, MAC users scheduling, frequency planning, propagation, path loss . . . ) supported by the RF network planning tools without disclosing any information. To solve this interesting problem, RF network planning companies provide extensions to support third parties implementations. Specifically, it would be possible to customize the calculations of propagation and path loss models (such as the CINR-based algorithms) while preserving the know-how of the companies.

Automated RF Planning and Optimization

The parameters for propagation and path loss models, and especially for the algorithms relying on RSSI, are typically estimated in an open loop fashion in the sense that no feedback loop or validation is required.

Algorithms such as automatic cell planning or automatic frequency planning are more complex, iterative, and need validation of intermediate solutions with respect to an objective function. Some tools provide the framework so that the user may only change quality metrics and some related threshold values. Other users could possibly customize the automatic frequency planning module to their specific implementation.

Advanced users may want to add their own modules, alter some configuration parameters and automate tasks with minimum programming. Such automation, not requiring user intervention, is possible for many commercial tools with add-ins, macros and scripts.

Adaptive Scheduling

One application of automating an RF network planning tool is the adaptive scheduling algorithm where a service provider would like to change some antenna parameters (e.g., azimuth direction, azimuth beamwidth, mechanical and/or electrical tilt) and possibly base station transmit power to handle deterministic congestion problems that happen at specific times of the day, week, month or season. This congestion may happen in highways and specific roads at rush hours or during time limited events in arenas and stadiums for example. The congestion is easily detected by the coverage hole detector 110 by, for example, the number of hourly connected subscribers per cell and subscribers experience (achievable throughput, dropped calls rate, etc.). Rather than having an RF engineer running repeated simulations, adjusting various parameters in each simulation, and then spending more time analyzing the results, it would be more advantageous to automate the process and let the tool come up with the best parameters for those specific times or events. The service provider will then apply the recommended parameters by means of scripts or an Application Programming Interface (API) that could be already available in the network management system (NMS) or network operation center (NOC).

Although the main purpose of changing parameters is traffic load balancing, there could be situations where coverage improvement and/or interference reduction/avoidance is the main objective.

Real-Time Change of Coverage Areas

Certainly, automating an RF network planning tool and improving the assumptions used in network planning, such as traffic maps, subscriber lists, propagation channel and path loss models, by means of the coverage hole detector 110 would save time and money for the service providers and would allow them to provide better coverage and make more accurate predictions for allocation of resources. The next natural step would be to dynamically change the coverage areas of selected cells whenever and wherever needed to solve congestion, degraded quality of service or, temporary unavailability, caused by equipment failure.

The commercial RF network planning tools available today have the common problem of converging very slowly, especially when dealing with a large number of sites. Advances in parallel processing and in the speed of computer processors could make these tools converge in a shorter time, and therefore, allow for real-time network optimization and load balancing, where changes to configuration parameters could be made hourly, or more frequently, depending on the situation.

Alternatively, an RF network planning tool could be drastically simplified for at least the closed loop portion that is implementing the real-time dynamic changing of coverage areas. Indeed, the API, available in commercial RF network planning tools, has a lot of restrictions. Also, most of the functions of an RF network planning tool are not required or could be implemented in much simpler fashion, such as through complementary modules to the coverage hole detector 110. Changing the coverage areas could simply rely on coverage maps and the distribution of subscribers in the network. A coverage map could be easily produced by the coverage hole detector 110 knowing the location of the subscribers and their Cell-ID. Changing cell boundaries could be done by means of, for example, a Voronoi-like type of algorithm, where the location of the subscribers and their quality of service, as well as the antenna capabilities of the sectors, could be taken into account. If the remote electrical capability is available for a specific sector's antenna, then the cell reach could be modified depending on the antenna tilt value. Also, a base station's transmit power or total channel bandwidth would have an effect on cell reach. If the azimuth pointing direction and/or the azimuth beamwidth of the antenna can be adjusted, then additional cell boundaries could be adjusted.

One objective of altering coverage areas could be load balancing to alleviate congestion problems that may occur. Subscriber density, provided by the coverage hole detector 110, is certainly a key input to the algorithm

Another objective of altering coverage areas could be self-healing. If one sector were to completely fail, selected surrounding sectors' coverage areas could be altered to pick up most of the traffic that normally would have been served by the failed sector, so that outage is minimized This would significantly improve the number of blocked calls in the failed sector and dropped calls in the surrounding sectors.

The location of subscribers is used in the feed forward loop to alter coverage areas while Key Performance Indicators, such as CINR and UL/DL throughput, especially if collected at slightly later time, will validate the changes as a feedback loop. The feedback loop shortens the time for converging towards the best solution in terms of network performance.

The simplified algorithms for dynamically changing coverage areas do not need sophisticated propagation and path loss models.

Interference management is inherently done inside the algorithms in a simple way, and its performance is checked as soon as the first batch of gathered data is parsed by the coverage hole detector 110. Depending on the scenario, load balancing may not always lead to the best solution due to complex propagation and interference. That's why the optimization objectives include better capacity, throughput, blocked and dropped calls rates, and cell edge throughput rather than evenly spreading the subscribers between the sectors even in the cases of load balancing and traffic congestion alleviation.

From the description provided herein, those skilled in the art are readily able to combine software created as described with the appropriate general purpose or special purpose computer hardware for carrying out the features of the invention.

Additionally, it should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

What is claimed is:

1. A method for detecting coverage holes in a wireless communication network, the method comprising:
collecting subscriber data from a plurality of subscribers in a plurality of coverage areas for coverage hole detection;
extracting relevant information from the subscriber data;
determining locations of the plurality of subscribers using the relevant information;
storing the relevant information from the subscriber data and the locations of the plurality of subscribers; and
displaying a coverage map generated from the locations of the plurality of subscribers in the plurality of coverage areas.

2. A program recorded on a computer-readable medium for detecting coverage holes in a wireless communication network, the program causing a computer to execute a method comprising:
collecting subscriber data from a plurality of subscribers in a plurality of coverage areas for coverage hole detection;
extracting relevant information from the subscriber data;
determining locations of the plurality of subscribers using the relevant information;
storing the relevant information from the subscriber data and the locations of the plurality of subscribers; and
displaying a coverage map generated from the locations of the plurality of subscribers in the plurality of coverage areas.

3. The coverage hole detection method of claim 1, wherein the locations of the plurality of subscribers are determined using an observed time difference (OTD) radio location algorithm.

4. The coverage hole detection method of claim 1, wherein the locations of the plurality of subscribers are determined using a round trip time (RTT) radio location algorithm.

5. The coverage hole detection method of claim 1, wherein the locations of the plurality of subscribers are determined using a received signal strength indicator (RSSI) radio location algorithm.

6. The coverage hole detection method of claim 1, wherein the locations of the plurality of subscribers are determined using information relating to or man-made structures.

7. The coverage hole detection method of claim 1, wherein the locations of the plurality of subscribers are determined using carrier to interference-plus-noise ratio (CINR) information correlated to geographic locations.

8. The coverage hole detection method of claim 1, wherein a near-real-time coverage map based is generated based on a continuous updating of the locations of the plurality of subscribers.

9. The coverage hole detection method of claim 1, wherein older relevant information and locations stored in the database are deleted so that only newer relevant information and locations are used when displaying the coverage map.

10. The coverage hole detection program of claim 2, wherein the locations of the plurality of subscribers are determined using an observed time difference (OTD) radio location algorithm.

11. The coverage hole detection program of claim 2, wherein the locations of the plurality of subscribers are determined using a round trip time (RTT) radio location algorithm.

12. The coverage hole detection program of claim 2, wherein the locations of the plurality of subscribers are determined using a received signal strength indicator (RSSI) radio location algorithm.

13. The coverage hole detection program of claim 2, wherein the locations of the plurality of subscribers are determined using information relating to or man-made structures.

14. The coverage hole detection program of claim 2, wherein the locations of the plurality of subscribers are determined using carrier to interference-plus-noise ratio (CINR) information correlated to geographic locations.

15. The coverage hole detection program of claim 2, wherein a near-real-time coverage map based is generated based on a continuous updating of the locations of the plurality of subscribers.

16. The coverage hole detection program of claim 2, wherein older relevant information and locations stored in the database are deleted so that only newer relevant information and locations are used when displaying the coverage map.

17. A communication system comprising:
a network optimization apparatus operable to monitor and perform management of the communication system;
a network controller operable to communicate with the network optimization apparatus;
a base station operable to communicate with the network controller;
an antenna array operable to communicate with the base station and a plurality of subscribers in a plurality of coverage areas;
a dynamic load balancing apparatus operable to communicate with the network optimization apparatus, the base station, and the antenna array; and
a coverage hole detector operable to detect coverage holes in the plurality of coverage areas, the coverage hole detector comprising:
a data collection device operable to collect subscriber data from the plurality of subscribers for coverage hole detection;
a parser operable to extract relevant information from the subscriber data;
a processor operable to determine locations of the plurality of subscribers using the relevant information;
an information database operable to store the relevant information from the subscriber data and the locations of the plurality of subscribers; and
a viewer operable to display a coverage map generated from the locations of the plurality of subscribers in the plurality of coverage areas.

18. A coverage hole detection apparatus comprising:
a data collection device operable to collect subscriber data from a plurality of subscribers in a plurality of coverage areas for coverage hole detection;
a parser operable to extract relevant information from the subscriber data;
a processor operable to determine locations of the plurality of subscribers using the relevant information;
an information database operable to store the relevant information from the subscriber data and the locations of the plurality of subscribers; and
a viewer operable to display a coverage map generated from the locations of the plurality of subscribers in the plurality of coverage areas.

19. The coverage hole detection method of claim 18, wherein the data collection device is a passive probe.

20. The coverage hole detection method of claim 10, wherein the passive probe collects the subscriber data from a link between the network controller and the base station.

21. The coverage hole detection method of claim 20, wherein the passive probe collects the subscriber data from a link between the network controller and a network management apparatus.

22. The coverage hole detection method of claim 18, wherein the network controller operates as the data collection device.
